(19) United States
(12) Patent Application Publication
(10) Pub. No.: US 2006/0292538 A1
(43) Pub. Date: Dec. 28, 2006

(54) Portable music machine

(75) Inventor: Jordan Kavana, Miami, FL (US)

Correspondence Address: Mr. Jordan Kavana;K Group Industries, LLC, 4770 Biscayne Blvd., Suite 980, Miami, FL, 33137, US

(73) Assignee: K Group Industries (Far East) Ltd., Miami, FL (US)

(21) Appl. No.: 11/166,949

(22) Filed: Jun. 24, 2005

(51) Int. Cl. G09B 5/00

(52) U.S. Cl. 434/307 A

(57) ABSTRACT

A portable music accompaniment device that is designed to generate a plurality of different rhythms based upon a user's voice. The device receives a signal of the user's voice and then generates a rhythm to match the user's voice depending on the style of music selected. The device includes a collar designed to be worn around a user's neck, with a housing connected to the collar. A microphone is also connected to the collar for receiving a voice signal from a user. A music generation component within the housing for generating music based upon the voice signal. A speaker is included for playing the music that is generated from the music generation component.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates to music devices. More specifically, the present invention relates to portable music accompaniment devices.

### BACKGROUND OF THE INVENTION

Recently, karaoke has constituted one of more popular entertainment activities without distinction to age and sex and gained a firm position in the bars and restaurants. In prior art systems, a recording medium is played back in a karaoke apparatus main body which may include speakers and a display device. A portable microphone may be connected to this karaoke apparatus main body via a flexible cord or by RF signals, and the voice signal from the microphone and accompanying melody played back by the karaoke apparatus main body may be transmitted to speakers so that the sound is output. At the same time, characters indicative of the title of the tune and lyrics of the accompanying melody, etc. are displayed along with background images on the display device.

In these systems, the karaoke apparatus main body is fixed in a selected position to enable it to operate correctly. Furthermore, the size of the apparatus normally tends to be large such that it is not portable. Portable karaoke machines have also been developed that eliminate the problems of having a fixed piece of equipment. Nevertheless, these machines are also limited as to the number of melodies that they can carry and, therefore, limit the choices of the user. Additionally, the portable karaoke machines do not permit a user complete freedom of movement. Further, known karaoke machines require the user to sing preselected lyrics, and do not allow for the creativity of the user to make up their own lyrics.

Accordingly, it would be beneficial to provide a portable music accompaniment device that is able to accompany a user singing their own lyrics. Additionally, it would be beneficial to provide a music accompaniment device that is able to generate its own music. Yet further, it would be beneficial to allow a user to move freely while using the device so that the user can dance to the music. It would be beneficial to provide a portable music accompaniment device that generates music based upon the singing voice and/or music preferences of the user.

### SUMMARY OF THE INVENTION

The present invention provides a portable music machine or accompaniment device. The portable music accompaniment device is designed to generate a plurality of different rhythms. The accompaniment device receives a signal of the user's voice and then generates a rhythm to match the user's voice depending on the style of music selected. The style of music may be selected from a wide variety of styles, such as hip-hop, dance, rap, Latin, rock, jazz or gospel. The device may include one or more controls and/or operating modes. Indicators may be provided for indicating which style of music and/or mode has been selected.

In particular, in one aspect, the present invention provides a portable music accompaniment device including a collar designed to be worn on a user's neck. A microphone is connected to the collar for receiving a voice signal from a user. A music generation component is provided for generating music based upon the voice signal. A speaker is also included for playing the music that is generated from the music generation component.

In one arrangement, the collar may be generally C-shaped having two ends, and wherein the microphone is positioned at one end of the collar such that the voice signal is received from the user's throat. In another arrangement, the speaker may be provided in a speaker component that is separate from the collar and comprises an RF receiver, the portable music accompaniment device further comprising an RF transmitter connected to the collar, such that music generation signals generated by the music generation component are transmitted to the speaker via RF signals. The speaker component may have at least one of a belt attachment hook, an armband and a carrying strap.

In some arrangements, a volume control may be included for controlling the volume of the music that is generated from the music generation component. The portable music accompaniment device may operate on one or more batteries such that the device may include a battery compartment for holding the one or more batteries.

In another arrangement, the music accompaniment device includes at least one indicator for indicating a status selected from, a music style, an operating mode, or a combination thereof. In one aspect, the indicators may include at least one light emitting diode. In still other aspects, the portable music accompaniment device can include a music style selector for selecting a style of music that the music generation component will generate. In certain aspects, the style of music is selected from hip-hop, dance, rap, Latin, rock, jazz or gospel. Finally, the music style selector may be constructed and arranged to select more than one style of music.

These and other embodiments are described in more detail below.

### BRIEF DESCRIPTION OF THE DRAWINGS

Other objects, features and advantages of the present invention will become apparent upon reading the following detailed description, while referring to the attached drawings, in which:

FIG. 1 shows a perspective view of a collar component of a music accompaniment device according to one embodiment of the present invention.

FIG. 2 shows a perspective view of a speaker component of a music accompaniment device according to one embodiment of the present invention.

FIG. 3 shows a schematic view of the music accompaniment device according to one aspect of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

The present invention provides a portable music machine or accompaniment device. The portable music accompaniment is designed to generate a plurality of different rhythms based upon the user's voice and the style of music selected by the user. The machine receives a signal of the user's voice and then generates a rhythm to match the user's voice.

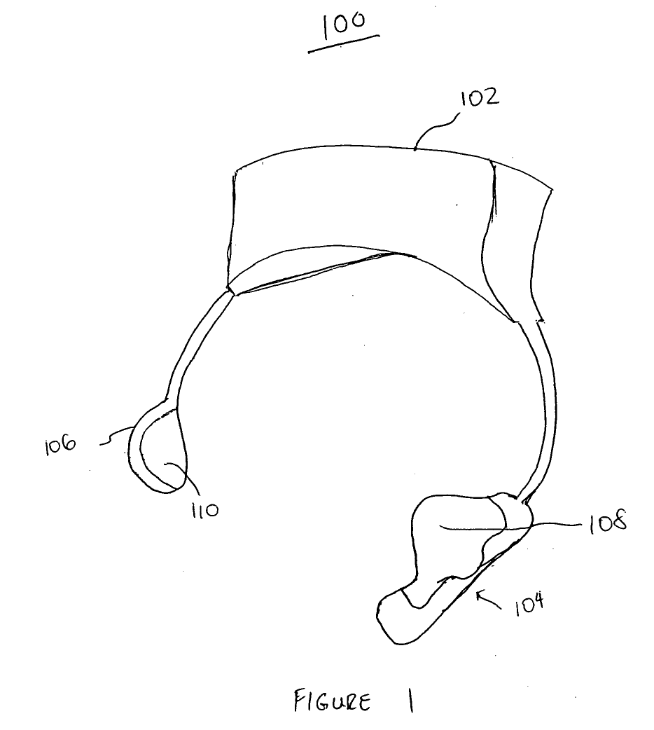

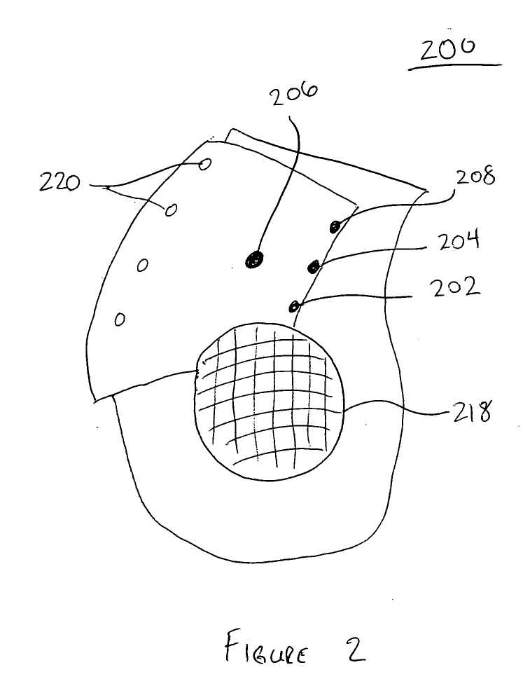

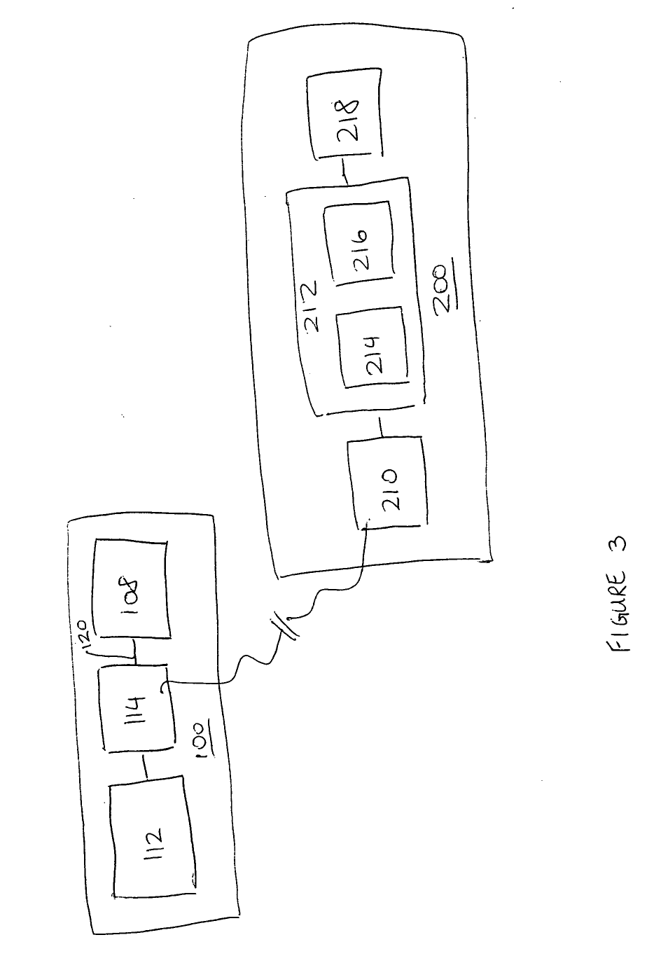

Reference will now be made to FIGS. 1-3 wherein the versatility of the devices of the present invention may be better understood. However, it is to be understood that these embodiments are for example purposes only and are not to be considered to be limiting in any manner of the overall scope of the present invention.

In one embodiment, the device may include a collar component 100 having a housing 102 located between a first end 104 and a second end 106. The collar component 100 may be generally C-shaped such that it may be placed upon a user's neck. The collar is preferably formed of a flexible plastic material, or may be hinged at one or more places for ease of placement around the neck. It will be appreciated that both ends of the collar do not need to extend around the neck the same distance, and that the term “C-shaped” is intended to cover any of several shapes of generally round collar having an opening to allow for placement on the neck. At the first end 104 of the collar, the device may include a microphone 108 that is placed in use on a user's throat to receive voice signals as the user sings. At the second end 106 of the collar, a flattened end 110 may be included that results in a better fit of the collar 100 on the neck of the user.

One or more batteries 112 or alternative power sources may be located in a battery housing within the housing 102 of the device 100, which is generally placed at the back of the user's neck in use. The housing 102 additionally contains an RF transceiver 114. Wires 120 connect the batteries 112 with the RF transceiver 114 and the microphone 108.

In one embodiment, the speaker component 200 is separate from the collar device 100 and includes a volume control 202, a demonstration mode switch 204, a wake-up mode switch 206, and a music style selector switch 208. An RF transceiver 210 is included within the speaker component 200. In addition to the switches, the speaker component 200 may also include a plurality of light emitting diodes (LEDs) 220 that may be used to signify which mode the device is in and/or what music-style is currently selected. The speaker component 200 communicates wirelessly with the collar device 100 via RF signals generated and received by the transceivers 118 and 210. The speaker component may include a belt hook, an armband and/or a carrying handle so that the user can carry the speaker component in a hands-free manner.

The speaker component 200 can include a music generation component 212, which may be any circuitry and software capable of generating music based upon a signal input. As such, based upon the signal input of a user's voice, as well as the style of music that was selected, the music generation component creates a rhythm that substantially complements the user's voice. In one embodiment, the music generation component 212 includes a voice sensor 214, which may be included in a voice sensor integrated circuit (IC) system that uses speech-recognition technology to detect a selected volume and/or vibration in a user's voice to activate the system. The music generation component 212 may also include a memory 216 which may contain preprogrammed rhythm or music tracks that are played during the time period that the voice sensor 214 detects that the user is singing or speaking. Alternatively, or in addition, the music generation component 212 may include a synthesizer to generate rhythm or music tracks according to predefined rules for particular music styles, or randomly. The output of the music generation component 212 is fed to a speaker 218. The user's voice input from the microphone 108 may also be fed to the speaker 218, to amplify the user's voice.

It will be appreciated that, although the devices of the illustrated embodiment of the present invention are designed to have wireless communication between the speaker component and the collar component, the speaker may be connected to the collar component by wires. Additionally, although in the illustrated embodiment the control switches and the music generation component 212 are included as part of the speaker component 200, they may alternatively be included on the collar component 100.

The music style selector switch 208 permits the user to select a particular music style in which the generated music will be created. While in certain embodiments of the present invention the device may have one style of music possible, in some embodiments, the devices of the present invention may include more than one style of music in which the music may be generated. For example, in one embodiment, the devices of the present invention may generate music in the hip-hop, dance, and/or rap styles. Other music styles may also be generated including, but not limited to, Latin, rock, jazz, gospel, or any other style in which a user may desire to have music generated.

The demonstration mode switch 204 and the wake up mode switch control demonstration modes and wake up modes respectively. In the demonstration mode, the device is instructed to play a selected musical style without requiring an input from the voice sensor to function. This mode can be used by the user to listen to and select the desired musical style prior to use. In wake up mode, the device is placed into a standby condition, wherein the device begins to play the selected musical style on activation of the voice sensor. The device is capable of shutting down after an elapsed period of time in the wake up mode to save battery power. In this condition, either a noise from the user or activation of a switch may be used to cause the device to return to active mode such that the user may again start using the device.

The volume control 202 may be included for controlling the volume at which the generated music may be played. In addition, the volume control may control the microphone volume as well, or a separate volume control may be included for controlling the microphone volume.

The devices of the present invention may include indicators for indicating various operating aspects to a user of the device. For example, an indicator may be provided to indicate which music style has been selected on the device. In another embodiment, an indicator may be provided to indicate whether or more modes on the device has been selected or activated. For example, an indicator may be provided to show that the device has entered wake-up mode. Alternatively, an indicator may be provided to indicate that the device is in demonstration mode. In one embodiment, the indicators are one or more lights sources that light up when a particular music style and/or mode has been selected. In one example, the light source is a light emitting diode (LED). Alternatively, the indicator may be a light bulb. Various colors of light bulbs or LEDS may be used such that a single indicator is provided that is capable of indicating several different modes and/or music styles.

It is to be understood that while the invention has been described in conjunction with the specific embodiments thereof, as well as the preceding examples, these embodiment and examples are intended to illustrate and not limit the scope of the invention. Other aspects, advantages and modifications within the scope of the invention will be apparent to those skilled in the art to which the invention pertains.

I claim:

1. A portable music accompaniment device comprising:
a collar designed to be worn on a user's neck;
a microphone connected to the collar for receiving a voice signal from a user;
a music generation component for generating music based upon the voice signal; and
a speaker for playing the music that is generated from the music generation component.

2. The portable music accompaniment device of claim 1, wherein the collar is generally C-shaped having two ends, and wherein the microphone is positioned at one end of the collar such that the voice signal is received from the user's throat.

3. The portable music accompaniment device of claim 1, wherein the speaker is provided in a speaker component separate from the collar and comprises an RF receiver, the portable music accompaniment device further comprising an RF transmitter connected to the collar such that signals generated by the microphone are transmitted to the speaker via RF signals.

4. The portable music accompaniment device of claim 3, wherein the speaker component has at least one of a belt attachment hook, an armband and a carrying strap.

5. The portable music accompaniment device of claim 1, wherein the music generation component is provided within a housing attached to the collar.

6. The portable music accompaniment device of claim 1, further comprising a volume control for controlling the volume of the music that is generated from the music generation component.

7. The portable music accompaniment device of claim 1, wherein the portable music accompaniment device operates on one or more batteries.

8. The portable music accompaniment device of claim 7, further comprising a battery compartment for holding the one or more batteries.

9. The portable music accompaniment device of claim 1, further comprising at least one indicator for indicating a status selected from, a music style, an operating mode, or a combination thereof.

10. The portable music accompaniment device of claim 9, wherein the indicator comprises at least one light emitting diode.

11. The portable music accompaniment device of claim 1, wherein the portable music accompaniment device includes a music style selector for selecting a style of music that the music generation component will generate.

12. The portable music accompaniment device of claim 11, wherein the style of music is selected from hip-hop, dance, rap, Latin, rock, jazz or gospel.

13. The portable music accompaniment device of claim 11, wherein the music style selector is constructed and arranged to select more than one style of music.

14. The portable music accompaniment device of claim 1, wherein the music generation component is a voice sensor integrated circuit system.
